(19) United States
(12) Patent Application Publication
(10) Pub. No.: US 2025/0123634 A1
(43) Pub. Date: Apr. 17, 2025

(54) DYNAMIC MACHINE AUTOMATION PLANNING SYSTEM

(71) Applicant: Kubota Corporation, Osaka (JP)

(72) Inventors: Bruce Jeffrey Thompson, Victoria (CA); Marc Roger Tibout, Montreal (CA)

(21) Appl. No.: 18/917,633

(22) Filed: Oct. 16, 2024

Related U.S. Application Data
(60) Provisional application No. 63/544,513, filed on Oct. 17, 2023.

(51) Int. Cl. G05D 1/648; A01D 34/00; A01D 101/00; G05D 1/646; G05D 1/69; G05D 105/15; G05D 107/20; G05D 111/30

(52) U.S. Cl. CPC G05D 1/6482; A01D 34/008; G05D 1/646; G05D 1/69; A01D 2101/00; G05D 2105/15; G05D 2107/21; G05D 2111/32

(57) ABSTRACT

A dynamic machine automation planning system that facilitates active machine mission planning. The system may flexibly modify mission plans for a plurality of machines associated with a project, including to facilitate fleet participation changes to add or remove machines during an active project. When replanning, the system may evaluate active completion status and select uncompleted sections for reassignment during a modification. Revised mission plans may be developed for one or more of the active machines based on system evaluation and user guidance.

### CROSS-REFERENCE TO RELATED APPLICATION

This application claims the benefit of priority from U.S. Provisional Application No. 63/544,513 filed on Oct. 17, 2023, titled “Dynamic Machine Automation Planning System,” the entire contents of which is incorporated herein by reference.

### BACKGROUND

Autonomous machines within the off-highway or other off-road machinery spaces (e.g., agriculture, turf, construction, and mining) often involve a single machine working on a task autonomously or in a semi-autonomous manner with human oversight. In some cases, multiple autonomous machines are working on a single mission, but are constrained to work in a specified zone to prevent interference with other machines within the mission.

Machine automation systems (e.g., vehicle automation systems) use an onboard operations system to drive and manage the machine (e.g., the vehicle). The system may also include onboard sensors to identify potential obstacles and provide feedback for driving and operating the machine. Some projects use multiple machines in one site with each machine assigned a different selection of project work paths.

Some systems disclose an option to add a machine to an active project by inserting a machine and assigning a set of existing work paths to maintain the scheduled plan. The new machine will begin operations at the start of an existing work path and follow predefined work paths sharing the work path operations with the existing machines. Some systems also describe removing a machine from an active project by having the machine complete one or more work paths and moving out of the way so that the remaining machines will not collide with the removed machine.

### SUMMARY

The present disclosure provides a system that may designate work paths within a project area and reassign work paths to accommodate altered machine numbers or replacement machine planning. The present disclosure may reassign the work paths at any time during active operation, including to replace or reassign machines to cover unfinished areas from an earlier mission plan for a machine. In some embodiments, a replacement machine may be directed or set up at a location in the middle or a work swath planned for an earlier machine. This provides efficient replanning without leaving dead zones from a prior mission plan or requiring a prior machine to finish a selected swath prior to removal.

In some embodiments, the system may operate over a networked ecosystem including a plurality of working machines with automated systems, such as machines designed for agricultural, construction, turf and logistics projects. Embodiments of the networked ecosystem may also include a remote cloud management system, a control system for project requests and information sources. The remote cloud management system may receive communications from the working machines, the control system and information sources.

In some embodiments, the remote cloud management system may include storage to hold and manage machine information and missions. In some embodiments, the cloud management system includes a collection of fleet missions, which may be assigned or preliminary. In some embodiments, the collection may be stored in a database format.

In some embodiments, the cloud management system facilitates mission planning development. The cloud management system may receive a mission plan request framing a project for a mission plan to accomplish from a control system. The control system may include a dedicated user interface. In some embodiments, a remote user interface accesses the control system via a wireless network connection, such as a mobile phone application.

In some embodiments, framing the project for a mission plan may include identifying a project location, boundaries, available materials and machines, project goals, project constraints and other information. In some embodiments, the remote user interface may also receive user operational planning selections for the mission planning system. The operational planning selections may include mission plan structure preferences, such as machine block planning, operational headlands, swath patterns, or other structural preferences. In some embodiments, the same user interface may be used for user approval or editing of a mission plan. In some embodiments, the control system may be used to define a mission plan using information from the cloud management system.

In some embodiments, the mission planning system is within the remote cloud management system. In other embodiments, the mission planning system may be integrated in a control system or end-user system. Embodiments of the mission planning system may include a path planning system, a safety analysis system, a scheduling system and other systems to define project instructions, boundaries, schedules, and controls.

In some embodiments, the path planning system will create path plans for each machine in a fleet for a project. The path plan for each machine may include the travel route and direction from a starting point through an end point for a project. In some embodiments, the operational path plan may include one or more work paths or swaths, operational headland passes and/or other operational passes. The path planning system may account for characteristics of each machine and implements, if applicable, including working width, turn requirements, speed, and other characteristics.

Embodiments may include a plurality of working machines. Each working machine may include a controller to manage and direct operations of the working machine. The controller may be a system with a computer to process and drive control actuators throughout the working machine. In addition, the controller may receive feedback regarding operations through various operational sensors, such as onboard perception systems, proximity sensors, location systems, working load sensors and other sensor systems to collect operational information in real-time.

Each working machine may also include a communication device configured to provide communication. In some embodiments, the communication device may be configured to transmit status information of the working machine and receive a set of machine instructions. In some embodiments, each working machine may send notice information relating to location, heading or actions for other machines to receive directly. In some embodiments, certain machine information may be broadcast by a machine. The communication system may receive communications including broadcast information about other machines. In some embodiments, the remote cloud management system may receive machine status information and track operations and locations of each machine in the machine fleet.

In some embodiments, the remote cloud management system includes storage to hold and manage mission development including machine activity instructions, machine profile information, and mission planning rules and limitations. Embodiments may also store mission plans, historical mission feedback, active mission status information and other information.

In some embodiments, the cloud management system facilitates mission planning development. The cloud management system may receive a mission plan request framing a project for a mission plan to accomplish from a control system. The control system may include a dedicated user interface. In some embodiments, a remote user interface accesses the control system via a wireless network connection, such as a mobile phone application.

In some embodiments, framing the project for a mission plan may include identifying account information, a project location or boundaries, available materials and machines, project goals, project constraints and other information. In some embodiments, the control system may be used to define a mission plan using information from the cloud management system.

In some embodiments, the remote cloud management system may include an automation system that develops mission plans based on machine profiles and mission activities. The automation system may identify a machine fleet to accomplish the project based on constraints and availability of machines. The machine fleet may include dissimilar machines operating with distinct technologies.

In some embodiments, the automation system may use each machine's profile and operation options within the machine's capability to build a common mission plan for the fleet and assign machine specific tasks compatible with each machine's operating technology.

In some embodiments, the working machine sends machine status information and updates for its machine profile via a long-range communication channel, such as cellular communication. The working machine may also receive updates, mission plans, and/or mission participant information. Each working machine may send direct communications to additional machines in an assigned fleet. In some embodiments, the mission plan may also include communication protocols for direct communication between dissimilar machines in the fleet. The communication protocols may address distinctions in the operating technologies and system languages.

In some embodiments, the machine characteristics are compiled during the manufacture of the machine and provided to the cloud management system through the API, which converts the characteristics, if needed, into the common machine profile format for the system. Machine characteristics may include multiple features, component descriptions and attributes of the machine, such as the speed, torque, power take off RPM, hydraulic power, clearance, etc. Machine characteristics may be determined during the installation and implementation of aftermarket automation systems for the machine in some embodiments.

Embodiments of the present disclosure may be configured to assign varied swath paths based on user inputs to accommodate interleaved, alternating, or other swath designs. In some embodiments, the mission planning system may assign block structures to each machine in the project plan and develop the mission plan within the assigned block structures. In some embodiments, a user may provide user inputs to modify block or swath assignments or manually edit selections from the mission planning system. The mission planning system may be configured to redevelop the mission plan instructions based on the user input.

In some embodiments, the mission planning system may receive a project update indicating a change in the machine fleet. The project update may be received from one or more machines within the active machine fleet. In some embodiments, a machine may send a notice indicating a malfunction, breakdown or other issues causing the loss of a machine from the active fleet. The notice may include an operational status update and information on the current location of the machine and whether the machine is able to move from the active field. In some embodiments, the same notice may be sent to a manager or other user to manage the appropriate maintenance or removal of the machine from the field.

The mission planning system may identify the leaving machine's work area in addition to other machine activity in the project area and revise the mission plan to open the remaining work area from the leaving machine and assign that work area to one of the remaining machines in the fleet. Alternatively, the mission planning system may split portions of the open work area among different working machines. In some embodiments, the mission planning system will send a revised mission plan for each machine to a remote user for authorization or modification.

In some embodiments, the mission planning system may receive a project update from a remote user indicating another machine is available for incorporation into the project machine fleet. The mission planning system may select portions of the uncompleted work areas for one or more machines in the fleet to open, thereby revising the mission plans for each affected existing machine. The mission planning system may then assign a mission plan in the opened sections to the new machine.

### BRIEF DESCRIPTION OF DRAWINGS

Embodiments will now be described, by way of example only, with references to the accompanying drawings in which:

FIG. 1 is an embodiment of a dynamic project map diagram;

FIG. 2 is another embodiment of a dynamic project map diagram;

FIG. 3 is another embodiment of a dynamic project map diagram;

FIG. 4 is an embodiment of a system diagram;

FIG. 5 is an embodiment of a system operation flowchart for mission planning;

FIG. 6 is another embodiment of a system operation flowchart for mission planning;

FIG. 7 is another embodiment of a system operation flowchart for mission planning;

FIG. 8 is an embodiment of a system operation flowchart for updated mission planning to add machine; and

FIG. 9 is an embodiment of a working machine operation flowchart for updated mission planning to remove machine.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein.

FIG. 1 illustrates an embodiment of a dynamic project map diagram. In this embodiment, the project map diagram is shown for a field 102 having a staging point 108 for the project. The project is assigned to a first working machine 104 and a second working machine 106. The project may be any project suitable for working machines, such as mowing, fertilizing, leveling, harvesting, spraying, etc. For purposes of discussion herein, the project may be referred to as a field fertilizing operation. Each working machine 104 and 106 may be spray fertilizers with a similar distribution width. Those skilled in the art will recognize that the spacing, path patterns and other aspects of the mission plan and incorporated operational path plan may be varied to accommodate different machine characteristics, such as different fertilizer distribution patterns.

In this embodiment, the working machines 104 and 106 are each assigned a path plan including travel paths and operational paths. The path plans in this embodiment are designed to begin and end in the staging point 108.

The path plan for the first working machine 104 follows an entry path 110 to an operational path 112, shown as a series of parallel swaths or passes with end turns, and ending with the egress path 114. The path plan for the second working machine 106 follows an entry path 116 to an operational path 118, also shown as a series of parallel swaths or passes with end turns and ending with the operational headland pass 120, which also facilitates egress. In this embodiment, the two path plans generally split the field 102 in half with the headland pass 120 configured for the final pass during egress of the second working machine 106.

In some embodiments, the field 102 may include assigned blocks for each machine 104 and 106. The mission planning system may generate path plans within the assigned block for each machine based on the machine and operational characteristics and features, such as size, turning radius, distribution width, travel speeds, and other characteristics. In some embodiments, the mission planning system may further assign blocks or swath patterns based on machine status information. For example, if one machine has a lower fuel level, the mission planning system may assign that machine to a block that facilitates a more fuel-efficient path.

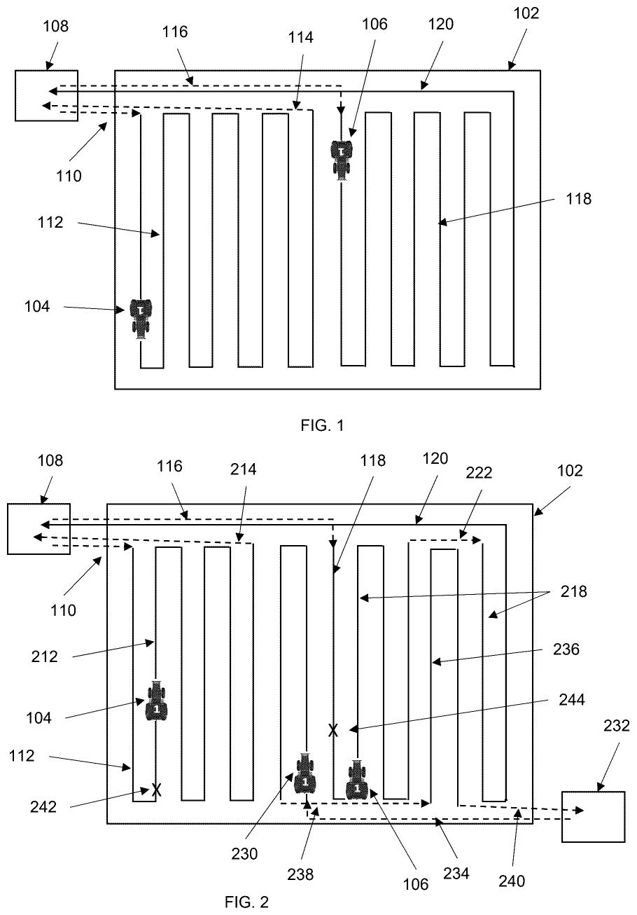

FIG. 2 illustrates an embodiment of a modified project map diagram for the field 102. In this embodiment, the project, which originally was assigned to a first working machine 104 and a second working machine 106, has been modified to incorporate a third working machine 230. In this embodiment, the third working machine 230 is also configured to come from a second staging point 232.

The modification occurs while the first and second working machines 104 and 106 are actively conducting the mission plan associated with the project map diagram in FIG. 1. In the embodiment shown, the completion point 242 indicates where the first working machine 104 was in its original path plan and the completion point 244 indicates where the second working machine 106 was in its original path plan.

In this embodiment, the inclusion of a third working machine 230 includes modifying the path plans for the first working machine 104 and the second working machine 106. In this embodiment, a new path plan for the first working machine 104 includes the same entry path 110 because the first working machine 104 had already completed this section of the path plan before a request to add a machine was received. The first portion of the operational path 112 may also have been completed as indicated by completion point 242. The mission planning system may resume the path plan and modify the remaining section of the operational path when adding the third working machine 230. In this embodiment, the first working machine 104 continues with the modified operational path 212 and ends with the modified egress path 214.

In this embodiment, a new path plan for the second working machine 106 includes the same entry path 116 because the second working machine 106 had already completed this section of the path plan before a request to add a machine was received. The first portion of the operational path 118 may also have been completed as indicated by completion point 244. The mission planning system may resume the path plan and modify the remaining section of the operational path when adding the third working machine 230. In this embodiment, the second working machine 106 continues with the modified operational path 218, which now include an internal travel path 222. In this embodiment, modified path plan also ends with the original headland pass 120 operating as an egress for the second working machine 106.

In some embodiments, the new path plans for the first working machine 104 and the second working machine 106 may not include any previously completed plan information. The new path plans may begin with the current location of each working machine 104 and 106 and proceed with travel or operational plans from that point forward. In some embodiments, new path plans may result in each machine starting and ending in different locations that previously planned. A machine may need to be moved to the location for the new path plan to resume operation. This may require a manual movement in some embodiments. In other embodiments, the new path plan may include an initial travel plan to reset the appropriate machine to the location to resume operations.

In this embodiment, a path plan for the third working machine 230 begins at the staging point 232 and proceeds along entry path 234 to an operational path 236, which includes travel path 238. The path plan for the third working machine 230 ends with egress path 240.

In some embodiments, the request to add a machine may include preferences for the assignment of the third working machine 230 to one existing project block or machine assignment. For example, a user may send a request to add a new machine to the working block assigned to the second working machine 106. The machine planning system may open a portion of the working block by removing it from the second working machine 106. The machine planning system may then assign a path plan in the opened portion of the working block to the third working machine 230.

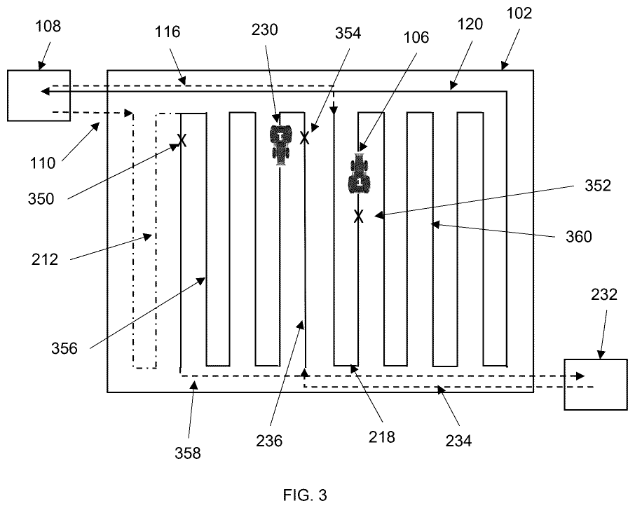

FIG. 3 illustrates another embodiment of a modified project map diagram for the field 102. In this embodiment, the modified project map diagram is a modification from the project map diagram shown in FIG. 2. For this example, the project may have been originally assigned to a first working machine 104, a second working machine 106 and a third working machine 230. In this embodiment, the first working machine 104 from FIG. 2 has been removed from the project while the three working machines 104, 106 and 230 were actively conducting the mission plan. In the embodiment shown, the completion point 350 indicates where the first working machine 104 was in the original path plan. Similarly, the completion point 352 indicates where the second working machine 106 was and the completion point 354 indicates where the third working machine 230 was in their original path plans.

The new dynamic project may be modified from the original to complete the project with the second working machine 106 and the third working machine 230. In this embodiment, the path plans for the second working machine 106 and the third working machine 230 have been modified to cover the remaining operations in the field 102. In this embodiment, the completed path plan for the first working machine 104 includes the same entry path 110 and a portion of the operational path 212 up to the completion point 350. The completed operational path 212 is shown in a dashed line until overlapping with the path plan for the third working machine 230.

A modified path plan for the second working machine 106 includes the same entry path 116 and the first portion of the operational path 218 up to the completion point 352. The mission planning system may resume the path plan and modify the remaining section of the operational path to account for the removal of the first working machine 104 and/or changes to the path plan for the third working machine 230. In this embodiment, the second working machine 106 continues with the modified operational path 360, which now proceeds the edge of the field without an interleaved path from the third working machine 230. In this embodiment, modified path plan also ends with the original headland pass 120 operating as an egress for the second working machine 106.

A modified path plan for the third working machine 230 includes the same entry path 234 from the staging point 232 and the first portion of the operational path 236 up to the completion point 354. The mission planning system may resume the path plan and modify the remaining section of the operational path to account for the removal of the first working machine 104 and/or changes to the path plan for the second working machine 106. In this embodiment, the third working machine 230 continues with the modified operational path 356, which now proceeds to the swath on which the first working machine 104 stopped at the completion point 350. In some embodiments, the third working machine 230 may pause operations while traveling over the overlapping section and resume operations when passing the completion point 350. In some embodiments, the mission planning system may set triggers for locations around the overlapping portions of the swath. In this embodiment, the third working machine 230 overlaps a portion of the swath completed by the first working machine and proceeds to the bottom of the field 102 until ending with a new egress path 358.

In some embodiments, the removal notice may include a request to assign coverage to a selected remaining machine, either the second working machine 106 or the third working machine 230 in this embodiment. In some embodiments, the mission planning system may be configured to assign the uncompleted section of the first working machine 104's project to one machine without effecting other machines in the fleet. In such embodiments, the one machine may be one of the remaining machines in the active fleet or a new machine added to the active fleet. The one machine may receive a new mission plan with coverage of the removed machine's remaining operational area while the other machines in the fleet resume their previously assigned mission plan.

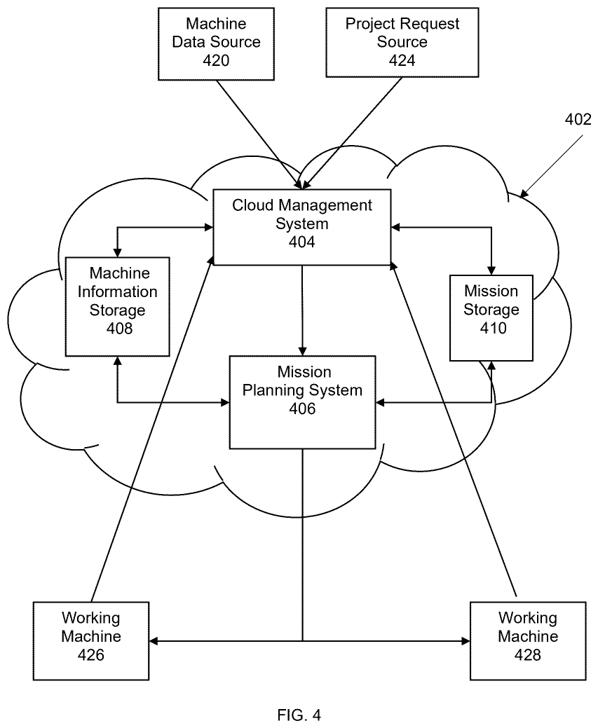

FIG. 4 illustrates an embodiment of a system using a cloud system 402 to manage working machines 426 and 428. In this embodiment, the cloud system 402 includes a cloud management system 404, a mission planning system 406, a machine information storage 408 and a mission storage 410. In some embodiments, the mission planning system 406 may include additional subsystems to manage development of one or more features of the mission plan. For example, some embodiments may include machine information analysis systems, program analysis systems, path planning systems, safety systems or other system components.

In some embodiments, these system components may be discrete components within the cloud system 402 or one or more dedicated servers. In other embodiments, the system components may be integrated. In some embodiments, certain component systems are maintained inside the mission planning system 406, while other system components are operatively connected to provide a service to the mission planning system 406 over a wireless connection, a wired network connection or direct wired connection, such as over a bus interface.

The machine information storage 408 and the mission storage 410 may be any type of electronic storage structure or memory device. In addition, the machine information storage 408 and the mission storage 410 may be stored within the memory structure in a variety of formats, such as a database, an indexed file system or other format. The machine information storage 408 and the mission storage 410 may store machine profiles, data, reusable digital assets, operational assets, automation scripts and other information.

The mission planning system 406 may access or receive information from the machine information storage 408 and the mission storage 410. In some embodiments, the mission planning system 406 may also send information to the machine information storage 408 or the mission storage 410. For example, finalized mission plans or portions thereof may be sent to the mission storage 410 for later evaluation or use.

In some embodiments, the machine information storage 408 maintains machine profiles for a plurality of working machines. The machine profiles for each machine may include detailed identification information, operational information, and other machine-specific characteristics, which operate as a configuration or information file for the machine. The identification information may include the machine's make and model data, serial number, owner, or user information, and/or other identifying information.

The operational information may include various machine operation information and capabilities, such as speed, torque, turn radius, size, PTO drive speed, sensor arrays, automation kits and control information, collision avoidance features, and other information. Additional information may include operation information for the machine-specific tools, such as tool load type, movement range, lift loads, reach, operational speed ranges, interactive limitations, and other information. For machines that may use a variety of optional implements, the relevant corresponding information for each optional implement may also be stored. In some embodiments, the base information for the machine may be stored with information from each optional implement to account for any changes to the machine operational information caused by connection to one implement or another. In some embodiments, the optional implements will include adjustment information that may be used during the analysis to update the machine operational information based on the connected implement.

The machine information storage 408 may also include operational history of the machine, information regarding known wear and tear or damage to the machine or specific components, scheduling information or other information regarding the use or maintenance needs of the specific machine. The machine information may include additional information about the current status of the machine, such as location, battery or fuel levels, currently attached accessories, and other status information. In some embodiments, the types of information may be stored as separate records for independent access and analysis. The machine information may store telematic and usage records, which indicate historical operations, usage data and logs, and current status information.

The mission storage 410 may include mission information, such as pending or completed mission plans. In some embodiments, the mission storage 410 may also include mission requests that have not been processed. The mission storage 410 may include mission feedback information, which may be evaluated and used for further mission planning or training mission planning systems.

In this embodiment, the machine information storage 408 may receive data from the cloud management system 404 based on information from a machine data source 420. Embodiments of the system may include any number of machine data sources 420. The machine data source 420 may include external user interfaces, such as phones, computers, server systems, tablets and other devices, used by manufacturers, mechanics, machine users, aftermarket suppliers and other sources. In addition, machine information storage 408 may receive information from working machines 426 and 428 directly. In some embodiments, the machine data source 420 may be the operator of the cloud structure system 402.

The mission storage 410 may receive information from the project request source 424 and mission planning system 406. In this embodiment, the cloud management system 404 facilitates the distribution of information from the project request source 424 and any additional feedback from working machines 426 and 428 to the mission storage 410.

In this embodiment, a single project request source 424 is identified. In other embodiments, a system may have multiple project request sources 424. The project request source 424 may be external user interfaces, such as phones, computers, server systems, tablets and other devices, used by any machine user, project manager or entity. In some embodiments the project request source 424 may be the operator of the cloud structure system 402. The cloud management system 404 may receive requests from the project request source 424 and direct the request to the appropriate mission planning system 406.

In some embodiments the mission planning system 406 or the cloud management system 404 may translate a project request into a standard format for the mission planning system 406 to parse and analyze. For example, the project request received from the project request source 424 may be a natural language request from the project manager, such as a request received in an audio format. The cloud management system 404 may convert the audio to text and identify the project definitions. In some embodiments, the cloud management system 404 may only convert the applicable key words for the project.

The mission planning system 406 may analyze the project request and evaluate the project definitions and goals to identify machine selection criteria (such as machine capabilities, locations, ownership limitations, scheduling availability, etc.), other fleet requirements, project operational areas, project timelines and other constraints, project goals and other project information.

In some embodiments, the project request will be developed through interaction between the cloud management system 404, the mission planning system 406 and the project request source 424 receiving feedback from the user. In some embodiments, the project request source 424 operates as a web interface to allow a user to operate a remote project service through the cloud management system 404. For example, a user may initiate a project request by opening an application on their tablet to access the cloud management system 404 and run a project planning service. The cloud management system 404 may receive project information and request specific instructions or guidance from the user in an interactive session. In some embodiments, the cloud management system 404 may begin mission planning through the mission planning system 406 during the user interaction. In such embodiments, the mission planning system 406 may provide preliminary selections for approval or options for the user to select from to further guide the mission plan features.

In some embodiments, the project request may identify one or more machines that will be used on the project. In such embodiments, the cloud management system 404 may send a query to the machine information storage 408 to obtain machine profiles and status information for the specified machines. The cloud management system 404 may include the machine information with the project request that is sent to the mission planning system 406.

In other embodiments, the mission planning system 406 may access machine information storage 408 to review machine profiles and identify machines that fit a project request. In some embodiments, the mission planning system 406 may send a query to the machine information storage 408 requesting machine profiles that meet a requirement of the project. For example, if the project requires machines located around a specific area the machine planning system 406 will send a query to the machine information storage 408 requesting all machines that are within a certain radius of the project area. In some embodiments, receiving a select group of the machine profiles increases the efficiency in the processing analysis to identify which machines are appropriate for the project and reduce processing requirements for the machine information storage 408 to allow other parallel requests without overburdening machine information storage 408's processor.

In some embodiments, the mission planning system 406 may receive machine criteria requirements, location information and other information from the cloud management system 404's project request analysis. The mission planning system 406 may use the machine criteria requirements during the analysis of the machine profiles to identify preferred machines for a project. In some embodiments, the mission planning system 406 will identify the preferred machines based in part upon planning efficiency, a location or other project feature. For example, if multiple options exist for the capabilities necessary to complete a project, the mission planning system 406 may determine which machines are compatible with project efficiency features, such as similar speeds, sizing or other feature that reduces planning variables thereby increasing planning and operational efficiency.

In some embodiments, the mission planning system 406 operates on the same structure, such as a server, with the machine information storage 408 and mission storage 410. Within cloud structure 402, the mission planning system 406 may be connected to the machine information storage 408 or the mission storage 410 over one or more communication systems depending on the underlying server array structure. For example, the mission planning system 406 may be implemented on a first server, using a processor and program memory connected via a wired bus. When evaluating machine information, the mission planning system 406 may use a first server communication card to access the Internet or other network in connection with the machine information storage 408.

In some embodiments, the processing operations may also be shared among multiple processors or separate computers to speed the evaluation through parallel processing operations. For example, the mission planning system 406 may assign separate computers to parallel process two distinct project requests. As another example, an operation assignment process may run on an independent server or processing system from a path planning system.

The mission planning system 406 may include a path planning system or access a path planning system service in some embodiments. The path planning system may develop a route or path plan for a machine to follow during the overall mission plan. The path plan may account for site geometry, site hard and soft boundaries, swath directions, machine operating and actual widths, machine turn options and capabilities, and other characteristics. In fleet planning, the path planning system may also account for the machine operations and characteristics for all machines in the fleet and identify distinct plans for each machine.

The mission planning system 406 may incorporate operational activities into the path plan, such as activity triggers for the project. For example, the mission planning system 406 may identify the soft boundary as a trigger for when to start and stop an action like mowing or spraying. In some embodiments, the soft boundary may identify a headland space for machine maneuvering within the hard boundary, such as a property line or physical impediment.

The mission planning system 406 may compile path plans, safety information, operational controls, triggers and instructions for the automation system to implement the mission plan. The mission planning system 406 may create or retrieve necessary scripting to achieve the project and tie together the various activity scripts needed for each operation. The operational scripts may be tailored to the machine that will receive the mission plan. If multiple machines are involved, the mission planning system 406 will create individual machine mission plans for each selected machine that are compiled to form a fleet mission plan for the project. The mission planning system 406 may then issue the mission plan to each working machine 426 and 428. The mission plan communication may be sent using a communication system network card over one or more communication channels to the communication modules and electronic control units on each working machine 426 and 428.

Working machines 426 and 428 may be any number of working machines. In addition, working machine 426 and working machine 428 may be the same type of machine. For example, working machines 426 and 428 may both be tractors with mowers that are assigned to a common field to share the responsibility of mowing the entire field. In other embodiments, working machine 426 may be a distinct type of machine from working machine 428. For example, working machine 426 may be a forklift designed to move loads around at a worksite and working machine 428 may be a crane at the worksite designed to lift certain loads up to the higher levels of a building under construction.

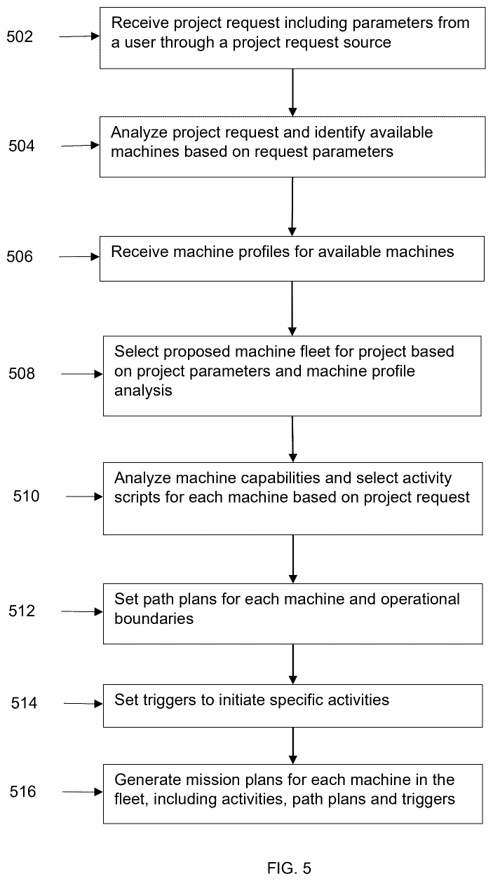

FIG. 5 illustrates a process for generating mission plans based upon project requests. The order of events in the process may change in some embodiments. Multiple steps may occur in parallel to increase efficiency in the processing and machine planning. In some embodiments, the project request may define certain elements allowing one or more steps to be skipped or optional in the development of a mission plan.

In box 502, the cloud management system 402 receives a project request including parameters from a user through a project request source. The project request source may be a phone, computer, tablet or other device used by a project manager to request a new project or redefine an existing project. The project request source may include a user interface with an output, such as a display, speakers and outputs, and inputs, such as a touch screen, buttons, switches, microphones or other inputs. In some embodiments, the project request source may send the request through a cloud interface.

In some embodiments, a project request is a defined request for a project utilizing automated machinery. For example, a farmer may submit a request for planting a field, which may require tilling equipment and planting equipment to be pulled behind a tractor. The project request may include multiple parameters and information about the project necessary to define the scope of the project, including anticipated machine capabilities and goals. For example, the project request may identify specific fields or location boundaries for the project, the crop type, the company or project lead information, and timing windows for the project. In some embodiments, the project request may provide available machine information or other fleet limitations.

In some embodiments, the project request may be a form that is presented to a user. The form may be presented to a user or an entity's project lead on the tablet, phone, computer or other user device. The form may include necessary information for a user to provide to request a project. For example, the form may require location information, requestor information, machine limitations, project goals, project time frame, project limitations and other information framing the project. The form may also include optional information categories, such as required or available machine limitations, scheduling requirements, path plan requirements, known obstacles, related projects and priorities, and other information that is relevant to the project.

In some embodiments, the mission planning system 406 may receive natural language or alternative project request formats, which are then transferred or translated into a categorized form for review and analysis. The standardized formats for project request information may be stored in an indexed database or relational database to streamline the analysis process.

In some embodiments, a plurality of project requests may be received and under analysis simultaneously. These requests may be organized to increase the analysis efficiency. For example, the projects may be prioritized by request timestamp and categorized by operating timeframes for the projects.

In box 504, the mission planning system 406 may analyze the project request and identify available machines based on request parameters. For example, the mission planning system 406 may review the project request to determine if any machines were identified in the request as default options. As another example, when the machines have not been identified in the project request, the mission planning system 406 may identify location scheduling or other machine related limitations from the machine information storage 408 and then identify the available machines based upon relative location to the project request location, availability during the defined window of the project request or other limiting information from the project request.

Once the available machines are identified, the mission planning system 406 may receive the machine profiles for those available machines as indicated in box 506. The mission planning system 406 may receive the machine profiles from the machine information storage 408 based on a request from mission planning system 406 indicating the identified available machines. In some embodiments, the mission planning system 406 may access the machine profiles for the available machines within the machine information storage 408. In some embodiments, the mission planning system 406 may analyze one or more features or characteristics found in the machine profiles by sending queries to the machine information storage 408.

In box 508, the mission planning system 406 may select a machine fleet for the project based upon project parameters and the machine profile analysis. For example, the mission planning system 406 may conduct a machine profile analysis to identify the machines having capabilities necessary for the project request and that are located closest to the project location. In some embodiments, the mission planning system 406 may also evaluate the readiness of each machine to participate in the project. For example, the mission planning system 406 may evaluate the machine's fuel levels, known wear and tear, maintenance schedule and other information regarding the ability to participate in the project.

In addition to the preferred machine features, the mission planning system 406 will select the machine fleet for the project based on an analysis balancing a variety of factors on the project, such as efficiency, economic requirements (fuel cost, transportation requirements, etc.), and project area capacity. As such, the selection of the proposed machine fleet will look at the availability of certain types of machines and the combination of available machines that provide preferred benefits.

For example, the mission planning system 406 may determine the most efficient means to fertilize the defined project area is to operate six automated fertilizer applicators pre-filled with fertilizer in tandem. If the required machines are available, the mission planning system 406 may assign the preferred six fertilizer applicators as the machine fleet. If six fertilizer applicators are not available, the mission planning system 406 may identify an alternative solution using three fertilizer applicators and a tender machine to periodically refill the applicators during the active operations.

In some embodiments, the initial machine fleet selection may be the closest selection of machines that are capable of performing the project. In other embodiments, the initial selection may be based on historical projects or input from the user. In some embodiments, the selection of a proposed machine fleet may begin with an initial fleet that is capable of meeting the project and modifying the fleet based on an analysis of alternative machines. The mission planning system 406 may replace an initial machine with an alternate machine for any number of reasons, including to protect the initial machine from wear and tear, to allow the initial machine to be available for another project, to include a more fuel-efficient machine or any other reason that favors exchanging one or more of the initial machines with an alternate machine to form the proposed fleet.

In box 510, the mission planning system 406 analyzes the machine capabilities of the machine fleet and selects activity scripts for each machine based on the project request. The mission planning system 406 evaluates the capabilities of each machine in the fleet to identify the applicable capabilities of each machine for the project. The mission planning system 406 may select activity scripts from the mission storage 410 according to the project request and the capabilities that each machine is facilitating. For example, an excavator may include capabilities for removing dirt for terra forming and removing rock obstacles. When the mission planning system 406 assigns projects for a fleet of machines including pan scrapers and excavators, the mission planning system 406 may assign one excavator the job to clear obstacles for the pan scrapers. The scripts assigned to that excavator may relate solely to the rock removal capabilities and not the dirt removal capabilities of the excavator. At the same time, other excavators in the fleet may be assigned dual operations for each type of capability.

The selected scripts may include initiation scripts for each machine which turn the machine on. In some embodiments, the initiation scripts may run automated diagnostics to ensure the machine is properly operating and its sensors and communication features are working to ensure safety in the automated operations. The selected scripts may be machine-specific languages for the machine's automation kit, which may differ across machines in the fleet.

In addition to the initiation scripts, the mission planning system 406 may select necessary operational scripts to achieve each desired operation for each machine. These may include the scripts for adjusting pan height for cutting a select grade, managing the movement speed consistent with expected ground conditions and other characteristics of the machine. Those skilled in the art will recognize that the various characteristics may be machine-specific options and vary by type of machine or make, model or specific machine capabilities.

In addition to selecting the appropriate scripts, the mission planning system 406 sets a path plan for each machine and/or the operational boundaries for the machine in box 512. The mission planning system 406 may select whether a path plan, an operational boundary or both may be implemented based on the project and nature of the machine's automated capabilities.

In some embodiments, the mission planning system 406 may set a path plan for each machine to follow. The mission planning system 406 may set a path plan as a preferred solution in some embodiments. The path plan may begin with a staging area and proceed through the expected operational path to a completion area. In some embodiments, the path plan may include optional additional routing to be determined with other machines in the fleet based on overall fleet progress. For example, for a fleet of two mowers, each machine may be assigned half of a field with the path plan including optional paths that overlap with the other machine's area. When the first machine finishes its half of the field, it may send a short-range communication to determine if the second machine is on schedule or behind schedule. If the second machine is sufficiently behind schedule, the first machine may complete an optional pass into the other area to speed up the overall completion time.

In some embodiments, the mission planning system 406 may use operational boundaries to define a complete area in which the machines may operate and move. For example, the operational boundaries may define static lines that the machine may not cross. These boundaries may or may not correspond to physical barriers in the area such as fences, ditches, walls or other physical barriers. In some embodiments, this area limits operation of the tool or accessory while allowing movement outside of the boundary while the tool or accessory is off. For example, a field may include a boundary section that operates as a break between crops. When plowing the field, the working machine may lift the plow to stop its operation while the machine turns within the boundary section of the field. In such applications, the mission planning system 406 may send an operational boundary and a machine boundary to differentiate movement limits from operation limits in the area.

In some embodiments, the mission planning system 406 may define the movement and operations using path plans and boundaries. For example, the machine may receive a path plan to define movement of the machine and an operational boundary to define when the operation should begin and end throughout the path plan.

In box 514, the mission planning system 406 sets triggers to initiate certain activities. For example, the mission planning system 406 may set the operational boundary as a trigger to start and stop machine operations. These triggers may initiate specific scripts to alter the standard operation when a trigger occurs, such as when an unanticipated obstacle is identified by the sensor system, another machine enters close proximity, a fuel level drops below a threshold, a goal for the machine is achieved or another event trigger occurs.

The mission planning system 406 may include several default trigger events and scripts for common operational matters, such as obstacle detection and avoidance, accessory engagement or disengagement, safety protocols, and other events. In addition, the mission planning system 406 may incorporate project specific triggers to initiate actions related to the specific underlying project. For example, the mission planning system 406 may include a refilling trigger for a fertilizer applicator to cause a refill request communication to be sent to a fleet tender machine when the onboard fertilizer falls below the threshold.

In box 516, the mission planning system 406 generates a mission plan for each machine in a fleet, which includes activities, path plans or boundaries, and triggers. The mission planning system 406 may also generate a fleet mission plan for the entire project. The fleet mission plan may be a compilation of each machine's individual mission plans. In some embodiments, the fleet mission plan may be sent as a single signal transmission to a fleet location to be received by each machine simultaneously.

In some embodiments, the mission plan may be designed for a single machine, and each machine in the fleet receives a specific mission plan and does not receive the fleet level plan. In these embodiments, the transmission of each mission plan may be more efficient, though in some cases the overall fleet transmission efficiency may be reduced.

The structure of the mission plan may further be defined based upon the machine profile information for the fleet of machines. For example, certain automation kits may use a global mission plan for the machines, while others may use machine-specific plans. The mission planning system 406 may refer to the selected machines' machine profiles to provide compatible mission plans for each machine in the fleet. In some embodiments, this may require the mission planning system 406 to generate two corresponding mission plan formats for a fleet with mixed automation kit protocols. In some embodiments, a single global mission plan may be generated and then parsed, if needed, prior to sending the mission plan to a machine-specific system.

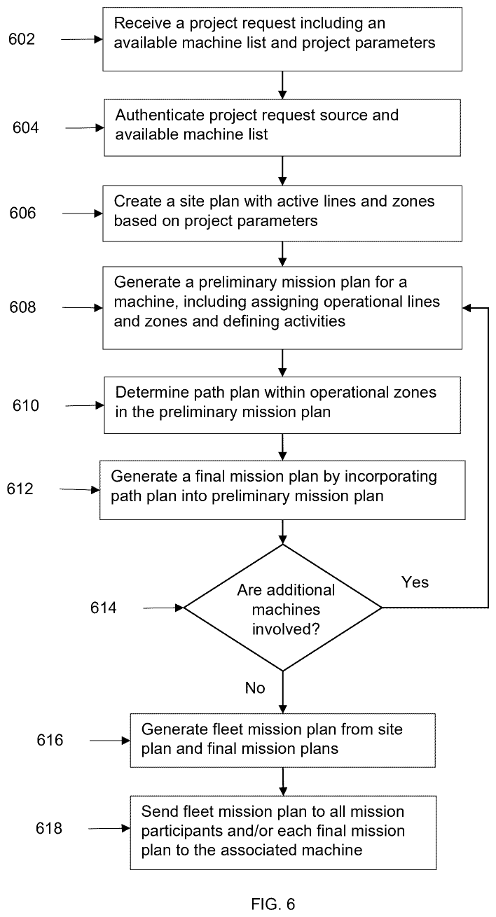

FIG. 6 illustrates another embodiment of a mission planning process. In box 602, the cloud management system 402 receives a project request, including an available machine list and project parameters. The cloud management system 402 may receive the project request via the project request source 424 from any authorized system participant, such as a project manager, a private owner, any entity owning or renting applicable machines or any other user. The user may provide or select machines they are authorized to assign to form an available machine list. In some embodiments, the user may also have the option to select whether rental machines may be included to address missing capabilities in the already authorized machines.

The project parameters may also be received from the project request source 424. In some embodiments, the project time and location constraints may be directly provided in the project request. The project time and location constraints may be indirectly determined from the project request parameters by the mission planning system 406 in some embodiments. The project parameters may also include geographic boundaries, accessible paths to the working location, detailed requirements and limitations for the operation or result, and other information.

In some embodiments, the project request source 424 may facilitate a form or define necessary information to enter a request that includes project parameters and available machines. In some embodiments, the geographic boundary may be dynamically selected on a map or other visual display selected by the user. For example, a user may select a map view of the location and select specific areas for operation. These may be identified in detail (e.g., GPS boundaries, relational boundaries or other formats) by the user or through an analysis of the user's selection by the mission planning system 406 as part of the site plan analysis.

In some embodiments, the project request may include authentication information. For example, the system may require a user to provide a profile name and password associated with an authorized account and associated machines. As another example, the project request submission may require digital recognition information such as a request originating from an approved phone number or IP address. In some embodiments, multiple forms of authentication may be required.

Once the form or other request format is completed and received, the cloud management system 402 authenticates the project request source 424 and available machine list in box 604. In some embodiments, this authentication may use authentication information received with the project request. This received authentication information may be compared to account authorization information and vehicle authorization information to ensure the received information properly corresponds.

In some embodiments, the authenticity of a project request may be verified through a multipart verification process. For example, the cloud management system 402 may request a username and password when the project request is submitted. The cloud management system 402 may receive the username and password along with the phone number or IP address associated with the user's device. The cloud management system 402 may then check authorized account records to identify an account associated with the username. Once an account associated with the username is identified, the cloud management system 402 may verify the password through a comparison process, which may use encrypted versions of the stored password and received password. If the password is verified, the authentication system may also confirm that the device identifier (phone number, IP address, etc.) corresponds to an authorized source. In some embodiments, a second step authentication may be used as well. For example, the cloud management system 402 may send an approval notice to another email or contact source in the cloud management system 402 account.

The initial authentication may be used for all access for the user within the cloud management system 402 in some embodiments. In other embodiments, additional verification steps may be required for confirming the available machine list. The machine authentication may rely on the same type of authentication or require an alternative authentication option as well. For example, the authorized users may be required to store a secure key and authenticator application for each machine.

If the authentication process indicates that the project request is not from an authorized user, device or otherwise, the cloud management system 402 may provide a new account set up option and provide information or forms for setting up the account. If the account is seeking use of preexisting machines or association with an existing account, the cloud management system 402 may send an approval request with the new user's information to an existing account or machine manager.

The cloud management system 402 information request for new users may include a machine registration option and authorization. For example, a user may be requested to identify a machine and provide detailed information. In some embodiments, the serial number or a code may be provided with a purchase order to identify the machine and the authorization for the cloud management system 402 to setup or download a machine profile from the prior owner or manufacturer.

If the account and machine list are authenticated for the project request, the cloud management system 402 may initiate the mission planning process within the mission planning system 406. In box 606, the mission planning system 406 creates a site plan with active lines and zones based on the project parameters. In some embodiments, the site plan may be primarily laid out in the project request, wherein the mission planning system 406 may conduct conversions to operational definitions for machines. For example, the project request may provide outlines on a map for the site plan and the mission planning system 406 may convert the outlines to GPS parameters for the mission planning system 406 and machines to use.

In some embodiments, general location information may be provided for identifying an area, which may be evaluated by the mission planning system 406 to determine the site plan. For example, a user may circle a selection of holes from tee to green for a mowing and fertilizing project on a golf course. The mission planning system 406 may determine the GPS boundaries of each hole from tee to green and separately identify boundaries for the green, which may have alternative requirements than the fairway. In addition, the mission planning system 406 may receive machine locations and identify available transition paths from the machine location to one or more staging areas adjacent to the site plan.

The mission planning system 406 may also develop site plans based on alternative selection options. For example, a user may identify a field using road markers and an owner name. The mission planning system 406 may confirm the location and owner through tax records and pull the plot for the site plan development. Arial images, such as Google map images or drone images, may be analyzed by the system to identify boundary items, such as fences, roads, plot lines or other boundaries, and visual obstacles, such as trees, ponds, large rocks and other apparent obstacles. Once this framework is determined, the mission planning system 406 may create a site plan accounting for all boundaries and anticipated obstacles.

In some embodiments, the cloud management system 402 may store previously identified site plans. For example, the developed site plans may be part of a project history storage system, which may be within the mission storage 410 in some embodiments. When a project is received and authenticated, the mission planning system 406 may compare project information and location information to previous projects and locations to see if the same project or location has been utilized before. If the same project is stored, the mission planning system 406 may seek confirmation from the user to use the prior mission plan. If the location has been used previously, the mission planning system 406 may pull any previously developed site plans for the location and send the site plans to the user to select the appropriate site plan for the current project. In other embodiments, the mission planning system 406 may evaluate the prior site plans to determine the appropriate site plan for the current project.

In some embodiments, the site plan may provide an overall project area and access avenues independent of specific machine operations or assignments. The site plan may be used as the backdrop for machine specific operation assignments for the mission plan.

In box 608, the mission planning system 406 generates a preliminary mission plan for a machine, including assigning operational lines and zones and defining activities. The preliminary mission plan may be built using the site map boundaries and available avenues for machine movements. The preliminary work may be configured to operate in a specific section of the site map based on the machine's starting location and staging area. If multiple machines will be used for common activities, the mission planning system 406 may create preliminary partitions to define the specific sections of the site map for each machine's mission plan.

In some embodiments, the mission plan defines active operational areas, wherein the machine performs an active operation separate from movement to the next location. As an example, an active operation may be mowing a field, fertilizing crops, delivering concrete into a frame, or other action. The machine may be required to make repeated travels across inactive spaces to reengage in an activity. For example, when planting crops, a machine may conclude a planting pass and disengage the planter while turning to align for a second planting pass.

In box 610, the mission planning system 406 determines the machine's path plan within operational zones in the preliminary mission plan. In this embodiment, the mission planning system 406 determines a vehicle path plan covering the operational zones assigned to the machine in the preliminary mission plan and manages the path plan's scope within the overall site plan. For example, the path plan may begin from the staging area and define a travel line that proceeds back and forth over the operational zone for the machine in multiple parallel or approximately parallel paths until that machine's operational zone is completed. In some embodiments, the machine may be assigned to additional zones that are connected by travel paths within the path plan. In addition, staging areas, interactive areas and other defined areas within the path plan may be flagged. For example, a mowing machine that is covering a series of fairways may pause at a staging area between two fairways to wait for a refueling machine interaction before proceeding on the path.

In some embodiments, the path plan may include a transition path from the storage area to a staging area adjacent to the operational zone. Similarly, some embodiments may include a conclusion step on the path plan to return the machine to a storage area or other area in preparation for another project.

Some embodiments may analyze the machine profile to determine spacing for each pass and define the paths according to the necessary spacing for the machine. For example, the mission planning system 406 may use the cutting width to determine pass separation for determining the path plan. As another example, the mission planning system 406 may use a spray pattern width for a liquid fertilizer applicator to ensure appropriate fertilizer coverage across the passes for determining the path plan spacing.

In some embodiments, the path plan may not be a serpentine or parallel path design. For example, the mission planning system may use a spiraled design either expanding from the center or contracting to a center. As another example, an abstract pattern may be formed to efficiently address obstacles. The path plan may also account for passes made by other machines. The path plans may also create abstract patterns to adjust passes for natural barriers, topographies, field management, water management, potential machine risks and/or field characteristics. In some embodiments, the path may be linear with periodic activity requirements. For example, an automated post hole digger may be assigned a straight-line path and a post hole digging activity with a set spacing between holes.

In some embodiments, the generation of a preliminary mission plan may include the creation of a machine's path plan. In such embodiments, the mission planning system 406 may create a path plan for a defined work area before or after the specific operations for the work area are defined.

These steps may also be processed concurrently, in some embodiments, and overlaid when completed. For example, the cloud management system 402 may include parallel processing paths or processing systems that are available for assignment by the mission planning system 406. In some embodiments, these processing systems may be networked computer systems, servers or other components that are customized for specific analysis features. For example, one server processing system may include specialized hardware, software and/or firmware tailored to define path plans from geographic data points and map constraints. The system may further require basic operation information, such as application width for the device, to define separation patterns for spacing within the path plan. This system may select and build a script pattern to follow the selected path plan. A second processing system may be tailored to define trigger zones and boundaries for script transitions during operation. This second processing system may associate operational scripts and transition scripts with specific geographic boundaries. These processing systems may therefore be more efficient than a consolidated system or serialized system. Those skilled in the art will recognize that the parallel processing options may be varied by project needs and efficiency thresholds. In addition, additional processing systems may be employed for redundancy and quality assurance checks.

In box 612, the mission planning system 406 generates a final mission plan for a machine by incorporating the path plan into the preliminary mission plan. As discussed above, this step may be accomplished as part of a parallel processing system or integrated processing system that creates the mission plan and path plan in tandem. The generation of the final mission plan for the machine may provide a formal step to transition a stored script and information for a machine, which may subsequently be part of a fleet mission plan to achieve the overall project. This final mission plan may be maintained in temporary storage, such as mission storage 410, in some embodiments. The final mission plan may alternatively or simultaneously be stored in a mission plan repository that may be used in subsequent project planning evaluations and development.

As an example of generating a final mission plan, the mission planning system 406 may use a third processing system to compile and align scripts for path planning operations and activity operations to form a complete script for the machine operations. In some embodiments, the various features of the machine operations may be received as partial scripts from separate processing systems prior to compilation. In some embodiments, the final mission plan may incorporate additional scripts for machine initiation processes, system check processes, trigger management scripts and other information for the machine's operations.

In box 614, the mission planning system 406 checks if additional machines are involved in the project. If so, the process repeats the steps in boxes 608 through 612 to develop a final mission plan for the next machine. This process may continue until the last machine is assigned a final mission plan.

In alternative embodiments, the development of final mission plans may be processed simultaneously. For example, the mission planning system 406 may identify all machines for the project and assign parallel processing options to complete steps provided in boxes 608 through 612 in tandem. In such an embodiment, the final check may confirm that all final mission plans are completed for each machine in the project fleet.

Those skilled in the art will recognize that a mission planning system 406 may employ both parallel and serial processing options depending on the circumstances and attendant efficiencies. For example, a fleet of mowing machines may be processed in parallel to a final mission plan, while a refueling machine in the fleet is processed serially behind the mowing machines in order to receive refueling marks and timing from each mowing machine mission plan.

Once all machines have been assigned a final mission plan, the process proceeds to generating a fleet mission plan from the site plan and final mission plans in box 616. The mission planning system 406 consolidates and compiles the final mission plans and the overall site plan into a fleet mission plan covering the complete project. During this step, the mission planning system 406 may conduct a quality assurance assessment to confirm that the mission plans are all within the permissible site plan, and that travel avenues allow for machines to access staging areas and move between separate work areas of the site plan.

As with other embodiments, generating the fleet mission plan may result in a single complete fleet mission plan for the cloud management system 402 and a package of machine-specific mission plans for each machine to use during the project. In some embodiments, the mission plan may include any staging requirements for the project requestor or machine provider. For example, the mission plan may include a schedule and instructions for the machine provider to ensure the machine is at a starting point or staging area by the project start time. Similarly, the mission plan may provide a notification for when the project should be completed and the location of a machine to be picked up by an owner or user. For locally stored machines, this aspect of logistics may not be necessary. Those skilled in the art will recognize that logistical notifications may relate to any number of operational guidance, such as confirming maintenance timing, prefilling fuel tanks, attaching any accessory items or other preparatory work to ensure the machines are staged and ready for operation at the project start.

In box 618, the cloud management system 402 sends the fleet mission plan to all mission participants and/or the machine-specific mission plans to each machine. The mission participants may include the selected machine fleet, an operation's hub or center, the project manager, machine handlers and others that may be involved in staging, operation or oversight for the project. In addition, the project request may include a list of non-machine mission participants.

As discussed with other embodiments, the mission plan sent to each machine may be the complete fleet mission plan or a modified version of the fleet mission plan tailored for each machine. In some embodiments, the mission plan is sent automatically after it is generated. Other embodiments facilitate a timed deployment of the mission plan to each machine. In yet other embodiments, the deployment of the mission plans to machines may include a staggered transmission process.

In some embodiments, the cloud management system 402 may streamline the transmission process to improve transmission efficiency and manage bandwidth considerations. For example, the cloud management system 402 may break the mission plan into smaller packets and send a stream of the packets over a dispersed time for a remote machine using a slower communication system. As another example, the cloud management system 402 may facilitate a near real-time transmission for a machine operating in a high-speed coverage area.

In some embodiments, the cloud management system 402 may send the entire mission plan to a hub local to the machine if it is directly connected to a high-speed transmission channel. The hub may then use a local communication system, which may be wired or wireless, to relay the mission plan to the machine. For example, the local hub may use the direct short-range communication system built into a machine's dual communication component for high-speed interactive communications.

In some embodiments, the cloud management system 402 may send a scheduling notification to the mission participants for future planned projects. The scheduling notification may also identify the timing for transmission of the mission plan and confirm signal quality and location. In some embodiments, a scheduled a start time may be included with the mission plan. The machine may then confirm its staging location and initiate the mission plan at the designated start time without an external notification. As an example, a golf course grounds keeper may set an automated mower with a course mowing mission plan to a starting location during the day. If the mission plan has a start time at 1 a.m. to avoid mowing while the course is active, the automated machine may wait in the starting location until the initiation process is triggered by the start time in the mission plan.

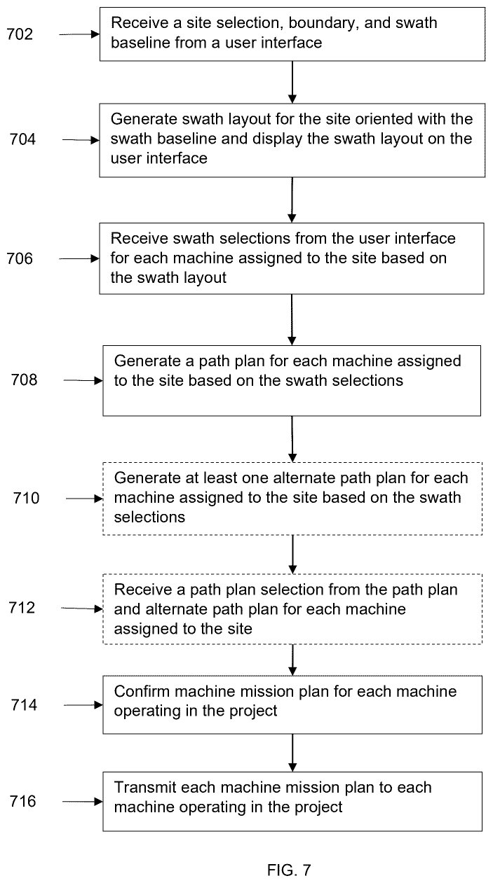

FIG. 7 illustrates another embodiment of a mission planning process. In box 702, the cloud management system 402 receives a site selection, boundary, and swath baseline from a user interface. The cloud management system 402 may receive the project request via a user interface associated with the project request source 424. The information may come from any authorized system participant, such as a project manager, a private owner, any entity owning or renting applicable machines or any other user. In some embodiments, the user may provide or select machines they are authorized to assign to form an available machine list. The user may also have the option to select whether rental machines may be included.

In some embodiments, the site selection may be a field, work site or other location. The location and site information may be selected from preexisting site options. In some embodiments, a site plan is selected and includes options for staging areas, starting locations, controlled zones, potential operational areas or paths, optional baselines and other site management and option information. In some embodiments, the site information may need to be loaded by a user or administrator prior to processing by the cloud management system 402.

A boundary may be associated with the site information or provided in addition to the site selection. In some embodiments, the boundary may be set based on user input, machine or equipment characteristics, site limitations, and/or other limitations. For example, the site may be associated with an operational boundary based on a fence line and a user may identify a different project boundary for the selected project. For example, a user with distinct crops may assign a boundary line between the different crops. In some embodiments, a site plan may include one or more optional boundary lines for selection.

In some embodiments, the user may select multiple boundary sections within a site for different options. For example, a user may assign distinct boundaries for each hole on a golf course and may separately provide activity boundaries for each green, bunker and hazard on each hole. In addition, travel paths may receive an alternate boundary indication. For example, the golf course may include fairway boundaries and travel paths between each fairway.

The swath baseline provides reference information for the mission and path planning to develop machine patterns. In some embodiments, the swath baseline is one edge of an identified boundary. In some embodiments, the swath baseline is selected from a site plan.

In some embodiments, the system may receive additional project parameters from the project request source 424, such as project scheduling. The project parameters may also include accessible paths to the working location, detailed requirements and limitations for the operation or result, and other information. In some embodiments, the user may also select or identify project guidelines, such as swath patterns, machine block assignments, operational headlands, and other guidelines.

In box 704, the mission planning system 406 may generate a swath layout for the site oriented with the swath baseline. The cloud management system 402 may send the swath layout to a user device to display the swath layout on the user interface. In some embodiments, the mission planning system 406 evaluates the project, site information, the characteristics of the machines, any user guidelines, and other information to determine swath structure, spacing, turns, and operational area limitations.

The mission planning system 406 may layout the swaths in a pattern oriented with the swath baseline. The pattern may include spacing, turns, and operational triggers based on the machine, site, and project evaluation by the mission planning system 406. In some embodiments, the swath spacing and patterns are generated based on default characteristics. In other embodiments, the swath pattern may be based on an aggregated evaluation of the machines assigned to the project. For example, the mission planning system may average the operational widths for all the machines involved in the project in order to determine space between each swath. In some embodiments, the swath layout may be generated by a path planning system within the mission planning system 406 or an alternative path planning system external to the mission planning system.

Once the swath layout is determined, the cloud management system 402 may send the swath layout to the requesting user. The user's device may display the generated swath layout on a user interface. In some embodiments, the swath layout may be displayed as a rough image of the site with general areas of operation outlined over the site. The level of detail for the swath layout may vary based on level of input or management facilitated by the cloud management system 402.

In box 706, the cloud management system 402 receives swath selections from the user interface. The swath selections are for each machine assigned to the site and are based on the swath selection. In some embodiments, the user may review the swath layout and assign each machine to selected swaths or groups of swaths through the user interface. For example, a user may have selected swaths for the left half of the field 102 to assign the first working vehicle 104 to that area of operation within FIG. 1. As another example, a user may have identified the interleaved swaths for the assignments of the working machines 104, 106 and 230 in FIG. 2.

In some embodiment, a user may review the swath layout and select an option for the cloud management system 402 to assign swaths to the selected machines. In some embodiments, the user may determine that a new swath layout should be generated and request a revised swath layout from the cloud management system 402. In some embodiments, the user interface may allow the user to modify swaths or break swaths into sections for selection.

In some embodiments, the user may also select other features of the site plan for guiding the mission planning process. For example, the user may select a staging area, an access point, activities for areas or swaths, and other information for the mission plan.

In box 708, the mission planning system 406 or an associated path planning system may generate a path plan for each machine assigned to the site based on the swath selections. In some embodiments, the path planning system will apply specific machine information to the assigned swaths to form the path plan for each machine in its own assigned area. For example, the path planning system may prepare a path plan from a machine's starting location to a first assigned swath for operation and through a selected pattern to travel and conduct the project operations.

In some embodiments, the path plan may include different spacing between swaths than the swath layout. Different spacing may be based on specific machine characteristics for the path plan in contrast to a generalized spacing attributed to multiple distinct machines considered for the swath layout. For example, the first machine may have a first distribution width that is less than distribution width for the second and third machines. The path planning system will provide path swaths for the first machine that are closer together than the path swaths for the second and third machines. If the swath layout showed swath spacing based on an average width, none of the path plans would correspond directly to the swath layout.

In addition, the path planning system will evaluate the edge characteristics between machine operation areas to minimize overlap and ensure the project area is properly covered. For example, the path planning system may require an extra pass of the first machine in an edge area due to insufficient operation width to cover the space between edge swath passes.

In some embodiments, the system includes optional boxes 710 and 712 for further user involvement. In optional box 710, the path planning system may generate at least one alternative path plan for each machine assigned to the site based on the swath selections. In some embodiments, the system may generate one or more alternative path plans. The alternative path plans may be configured to illustrate options within the selected swaths. In some embodiments, the mission planning system 406 may provide an option that is not consistent with the selected swaths for a user to evaluate. In some embodiments, the path plans may include a report of anticipated status, timing, efficiency, fuel economy, or other information for the user to consider.

In optional box 712, the cloud management system 402 receives a path plan selection from the path plan and alternative path plan for each machine assigned to the site. The path plan selection may be received from the user interface associated with the project request source 424. In such embodiments, the system may facilitate user path plan selections and store selection results, feedback, and other information. In some embodiments, this information may guide future path planning generation.

In box 714, the system confirms the machine mission plan for each machine operating in the project. In some embodiments, the cloud management system 402 conducts a fleet simulation analysis to confirm each mission plan. In some embodiments, a user may review and confirm each mission plan. The user may be able to reject a mission plan to cause the cloud management system 402 to generate another mission plan. In addition, the user may provide restrictions, requests, or other information to guide the cloud management system 402 in developing a plan. In some embodiments, the cloud management system 402 may facilitate a user manually entering revisions and modifications to the mission plan. In such embodiments, the cloud management system may reevaluate the final mission plan to ensure accuracy, safety, and other features of the plan.

In box 716, the cloud management system 402 transmits each machine mission plan to each machine operating in the project. In some embodiments, the cloud management system 402 sends a communication including the mission plan wirelessly to each machine through a selected communication network. The machines may have application gateways with authentication systems corresponding to the cloud management system 402.

In this process, the development of the mission plans for the fleet are generally described as a parallel or contemporaneous effort. In some embodiments, this process may be serially conducted. For example, the cloud management system 402 may develop a mission plan for a first machine from receiving swath selections through transmitting the mission plan to the machine. The cloud management system 402 may then repeat the process for the next machine until all machines have been assigned.

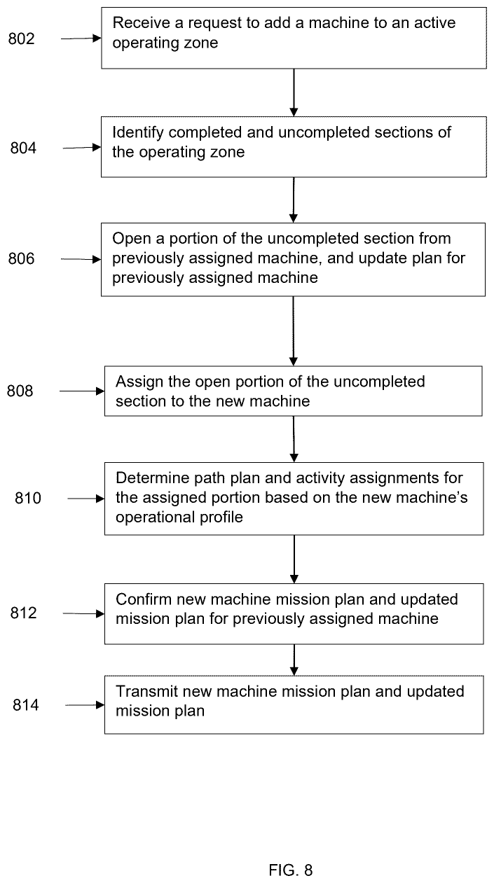

FIG. 8 illustrates an embodiment of a mission planning process to update a mission plan to add machine. In box 802, the cloud management system 402 receives a request to add a machine to an active operating zone. In some embodiments, the request may be received from a project request source 424, such as a user device running a corresponding application. A user may complete a request or notice of availability for a new machine to be included in the project. The cloud management system 402 may initiate a mission planning update to add the machine.

In some embodiments, the cloud management system 402 may transmit a notice to the active machines, such as the first and second working machines 104 and 106 in FIG. 1. The notice may request status updates for each machine, including location on the active path plan.

In some embodiments, the notice may also initiate a pause or set a pause location. A pause may be necessary in some embodiments wherein transmission delays, processing times, activities, or other circumstances may interfere with updated mission planning analysis to accommodate a new machine. For example, if a machine moves significantly forward on their path after sending the completed location information, the mission planning system 406 may plan modifications based on aged information. The updated mission plan may not coincide with the additional operations and travel conducted by the machine in the interim.

In some embodiments, the machines may continue to operate and the mission planning system 406 will be configured to account for a predicted location on the path. The system may be able to use active speed and path information to accurately identify where the machine will be when the updated mission plan is transmitted back to the machine. In some embodiments, the machines may determine whether or not to pause based on current communication speeds. For example, each machine may compare a timestamp in the notice with the received timestamp to determine communication speed and potential for processing errors due to continued operation.

In box 804, the system identifies completed and uncompleted sections of the operating zone. For example, the mission planning system 406 may receive the location status from each active machine and identify all areas covered in the path plan as completed and all remaining areas as uncompleted. In some embodiments, the mission planning system 406 will identify the completed and uncompleted swaths and portions of swaths. The mission planning system 406 may identify the completed and uncompleted sections for all active machines. In some embodiments, the mission planning system 406 may only evaluate completed and uncompleted sections of a machine's path plan. For example, the request to add may include specific instructions to add the new machine to a specific active machine's operating zone.

In some embodiments, the request may identify specific swaths, operating blocks, headland passes or other areas for the new machine. The mission planning system 406 may evaluate each designated area for completed and uncompleted zones. In such an analysis, the evaluation may relate to a limited set of the active machines.

In some embodiments, the cloud management system 402 may send a status update with active paths marked to display to a user a current completed and uncompleted view of the project. In some embodiments, the cloud management system 402 facilitates a near-real time status map for a remote user to review and manage operations. In some embodiments, the request to add a new machine may be received from within the remote monitoring system.

In box 806, the system opens a portion of the uncompleted section from a previously assigned machine and updates the mission plan for the previously assigned machine. For example, the mission planning system 406 may open the last two passes of the first working machine 104 in FIG. 1 and generate the modified operational path 212 and new egress path 214 to update the first working machine 104 as shown in FIG. 2.

In some embodiments, the system may open portions of the uncompleted sections from more than one of the previously assigned machines and update all machines that were impacted. Turning back to FIGS. 1 and 2, the mission planning system 406 may also open a pair of passes within the operational zone of the second working machine 106. In this example, the passes are in the middle of the prior operational path 118, leading to a new travel path 222 around the opened passes. The mission planning system 406 may generate the updated mission plan accordingly as shown in FIG. 2.

In some embodiments, the remote management system may allow a user to select one or more portions of the uncompleted zones for assignment to the new machine. In some embodiments, these selections may be transmitted with the request to add notice. When the selections are processed by the mission planning system 406, the same sections may be opened by the system, or a warning may be sent to the user indicating potential risks or drawbacks to such selections.

In box 808, the system assigns the open portion of the uncompleted section to the new machine. In some embodiments, the open portion may relate to uncompleted sections from multiple machines. The mission planning system 406 may assign the open portion to the new machine.

In box 810, the system determines a path plan and activity assignments for the assigned portion based on the new machine's operational profile. In some embodiments, the mission planning system 406 will use a path planning system to determine the applicable path in the assigned portion of the site. The path planning system may use the machine's operational profile to determine appropriate spacing and turn options to develop the machine's route. For example, the path planning system may have determined the path for the third working machine 230 should begin with the passes opened from the previously assigned first working machine 104 before moving to the swaths opened from the previously assigned second working machine 106. The path planning system may have determined this path plan for efficiency, safety, ease of operation or for other reasons.

In some embodiments, the path planning system may also assign the activities to the path plan for the machine. In other embodiments, the path planning system provides the route of travel and the mission planning system 406 may assign activities. The activities may include operational boundaries within the path plan, equipment controls, and other activities. For example, if the path planning system provides a route along a new fence line, the mission planning system 406 may set hole digging activities along the path plan to set posts for the fence. The activity may include machine stops, engaging and managing equipment, resetting equipment for travel, and other steps to achieve the operational objectives.

In some embodiments, the mission planning system 406 may use operational boundaries to set triggers to pause operations when leaving the operational zone and resume operations when entering the operational zone. For example, a crop sprayer may spray along swaths adjacent to the crops and pause at the headland for the machine to turn around for the next pass.

In box 812, the system confirms the new machine mission plan and any updated mission plans for previously assigned machines. In some embodiments, the cloud management system 402 conducts a fleet simulation analysis to confirm each mission plan. The analysis may confirm project objectives, accuracy, safety, and other features of the plan.

In some embodiments, a user may review and confirm each mission plan through a user interface associated with the cloud management system 402 or project request source 424. The user may be able to reject a mission plan to cause the cloud management system 402 to generate another mission plan. In addition, the user may provide restrictions, requests, or other information to guide the cloud management system 402 in developing a plan. In some embodiments, the cloud management system 402 may facilitate a user manually entering revisions and modifications to the mission plan. In such embodiments, the cloud management system may reevaluate the final mission plan to ensure accuracy, safety, and other features of the plan.

In box 814, the system transmits the new machine mission plan and any updated mission plans. In some embodiments, the cloud management system 402 sends a communication including the relevant mission plan wirelessly to each machine through a selected communication network. The machines may have application gateways with authentication systems corresponding to the cloud management system 402. In embodiments that have paused operations based on the request to add a machine, the receipt of the updated mission plan may initiate a resumption of operations.

In this process, the development of the new and updated mission plans for the fleet are generally described as occurring collectively prior to the transmission update. In some embodiments, this process may be serially conducted including the steps of transmitting the new or updated mission plan once it is generated. In such embodiments, the system may reduce inactive time for the working machines. In embodiments that account for ongoing operations, providing updates may not immediately affect operational timing and efficiency.

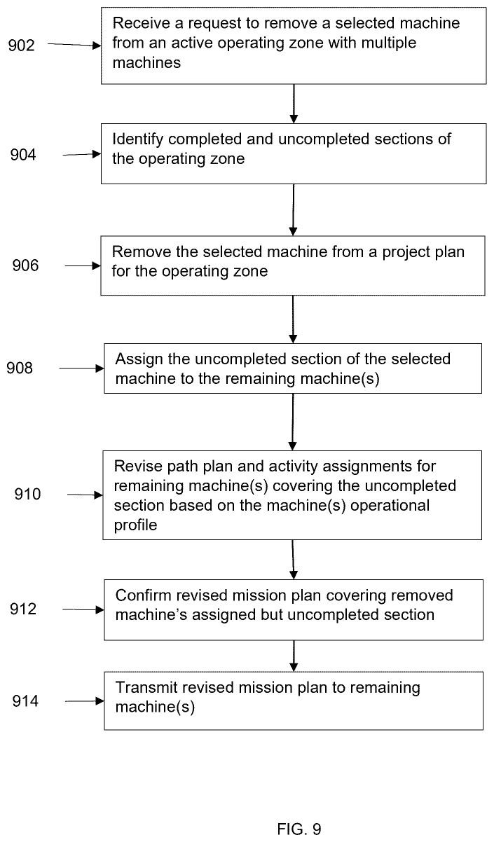

FIG. 9 illustrates an embodiment of a mission planning process to update a mission plan to remove a machine. In box 902, the cloud management system 402 receives a request to remove a machine from an active operating zone. In some embodiments, the request may be received from a project request source 424, such as a user device running a corresponding application. A user may complete a request or notice to remove a machine from the project.

In some embodiments, a machine may send a notice that operates as a request to remove a machine. For example, if the machine has an equipment malfunction, the machine may send a status notification indicating the malfunction and inability to perform the operations. The malfunction may be characterized in the notice to allow the system to determine whether there is a concern that the machine is an obstacle for the site based on the malfunction. For example, if the machine blew a tire and is unable to move, the cloud management system 402 may send an obstacle warning to the active fleet, send a repair notice to a site manager, and/or provide additional safety instructions. In such embodiments, any revised path plan may account for the machine's location until an update is received indicating the machine is clear from the site.

The cloud management system 402 may also initiate a mission planning update to remove the machine. In some embodiments, the cloud management system 402 may transmit a notice to the active machines, such as the second and third working machines 106 and 230 in FIG. 2, that another previously active machine, such as the first working machine 104, is being removed from the project. The notice may request status updates for each machine, including location on the active path plan.

In some embodiments, the notice may also initiate a pause or set a pause location for the active machines. A pause may be necessary in some embodiments wherein transmission delays, processing times, activities, or other circumstances may interfere with updated mission planning analysis to accommodate removing the machine. In some embodiments, the machines may continue to operate and the mission planning system 406 will be configured to account for a predicted location on the path.

In box 904, the system identifies completed and uncompleted sections of the operating zone. For example, the mission planning system 406 may receive the location status from each active machine and identify all areas covered in the path plan as completed and all remaining areas as uncompleted. In some embodiments, the mission planning system 406 will identify the completed and uncompleted swaths and portions of swaths. The mission planning system 406 may identify the completed and uncompleted sections for all active machines including the machine to be removed. In some embodiments, the mission planning system 406 may only evaluate completed and uncompleted sections of the removed machine's path plan. For example, the cloud management system 402 may be configured to allow the remaining active machines to continue their assigned paths prior to accommodating any uncompleted section of the removed machine's path.

As another example, a user request to remove a machine may also identify a machine to which to assign the uncompleted section of the path. The cloud management system 402 may only evaluate the removed machine and the assigned machine's current status. Similarly, the request may identify specific swaths, operating blocks, headland passes or other areas for one or more remaining active machines. The mission planning system 406 may evaluate each designated area for completed and uncompleted zones. In such an analysis, the evaluation may relate to a limited set of the active machines.

In some embodiments, the cloud management system 402 may send a status update with active paths marked to display to a user a current completed and uncompleted view of the project. In some embodiments, the cloud management system 402 facilitates a near-real time status map for a remote user to review and manage operations. In some embodiments, the request to remove a machine may be received from within the remote monitoring system.

In box 906, the system removes the selected machine from a project plan for the operating zone. For example, the mission planning system 406 may cancel the mission plan assignment of the first working machine 104 in FIG. 2. This may open the swaths for the uncompleted section of the mission plan for the first working machine 104. While the mission plan assignment is removed for the machine, the cloud management system 402 may continue to communicate with the machine to confirm the location of the machine until it is off the site or placed in a safe location.

In box 908, the system assigns the uncompleted section of the selected machine to the remaining active machines. In some embodiments, mission planning system 406 may assign the open swaths to one or more remaining machines. For example, the open swaths from the first working machine 104 path plan 212 in FIG. 2 are assigned to the third working machine 230 as shown in FIG. 3.

In some embodiments, the mission planning system 406 may determine additional path modifications may be preferable for the active fleet collectively. The system may open portions of the uncompleted sections from more than one of the previously assigned machines and update all machines that were impacted. Turning back to FIGS. 2 and 3, the mission planning system 406 may also open passes within the operational zone of the third working machine 230. In this example, passes in the middle of the prior operational path 236 are reassigned to the second working machine 230. The mission planning system 406 may generate the updated mission plans accordingly as shown in FIG. 3.

In some embodiments, the remote management system may allow a user to select one or more portions of the uncompleted zones for assignment to a specific active machine. In some embodiments, these selections may be transmitted with the request to add notice. When the selections are processed by the mission planning system 406, the same sections may be assigned by the system, or a warning may be sent to the user indicating potential risks or drawbacks to such selections.

In box 910, the system revises path plans and activity assignments for the remaining machines covering the uncompleted section based on each machine's operational profile. In some embodiments, the mission planning system 406 will use a path planning system to determine the applicable path in the assigned portions of the site for each remaining active machine. The path planning system may use the machine's operational profile to determine appropriate spacing and turn options to develop the machine's route. For example, the path planning system may have determined the path for the third working machine 230 should turn to cover the uncompleted section of the previously assigned first working machine 104. The path planning system may have determined this path plan for efficiency, safety, ease of operation or for other reasons.

In some embodiments, the mission planning system 406 or the path planning system may also assign the activities to the path plan for the machine. The activities may include operational boundaries within the path plan, equipment controls, and other activities. In some embodiments, the mission planning system 406 may use operational boundaries to set triggers to pause operations when leaving the operational zone and resume operations when entering the operational zone. Similarly, triggers may be used to manage travel routes within the operational zone, which may be included to move to another active swath without duplicating operations in the travel area.

In box 912, the system confirms the revised mission plans covering the removed machine's uncompleted section of the site. In some embodiments, the cloud management system 402 conducts a fleet simulation analysis to confirm each mission plan. The analysis may confirm project objectives, accuracy, safety, and other features of the plan.

In some embodiments, a user may review and confirm each mission plan through a user interface associated with the cloud management system 402 or project request source 424. The user may be able to reject a mission plan to cause the cloud management system 402 to generate another mission plan. In addition, the user may provide restrictions, requests, or other information to guide the cloud management system 402 in developing a plan. In some embodiments, the cloud management system 402 may facilitate a user manually entering revisions and modifications to the mission plan. In such embodiments, the cloud management system may reevaluate the final mission plan to ensure accuracy, safety, and other features of the plan.

In box 914, the system transmits the revised mission plans to the remaining active machines. In some embodiments, the cloud management system 402 sends a communication including the relevant mission plan wirelessly to each machine through a selected communication network. The machines may have application gateways with authentication systems corresponding to the cloud management system 402. In embodiments that have paused operations based on the request to add a machine, the receipt of the updated mission plan may initiate a resumption of operations.

In this process, the development of the revised mission plans for the fleet are generally described as occurring collectively prior to the transmission update. In some embodiments, this process may be serially conducted including the steps of transmitting the revised mission plan once it is generated. In such embodiments, the system may reduce inactive time for the working machines. In embodiments that account for ongoing operations, providing updates may not immediately affect operational timing and efficiency.

In some embodiments, a mission plan may not use a path plan for automation. In such embodiments, the system may generate modified mission plans to accommodate a change in the machine fleet without using path plans. For example, if a project has two active machines mowing a field. Each machine has a mission plan defining its field boundaries forming a project area and the machine is configured to automatically determine a path for its project area. During operation, each machine may record completed paths or areas. When a new machine is added, the system will treat all completed areas as outside the project and redistribute areas for each machine by defining field boundaries that do not encompass the completed areas. Each machine may receive a new mission plan with a new set of field boundaries. Wherein each machine may then automatically process its own area for the project.

As another example, excavators may be assigned mission plans to dig a hole in a specified zone. The excavators may be free to automatically determine the process and operations for digging in its specified zone. Each excavator may record information regarding the zone and progress on digging the hole, such as depth or topographical information in specified areas within the zone. If the excavator is replaced, the next machine may receive a similar mission plan for the specified zone along with the updated topographical information from the first excavator.

In other embodiments, an assigned mission plan may include a mixture of path plans and project areas or zones. For example, a golf course mowing project may include a mission plan with field boundaries to mow each fairway and a path plan to travel between fairways. Mission plan modifications may include revised path plans and/or field boundaries for the mowing fleet. As another example, a mission plan may assign distinct zones for different yard sections for a mower to automatically mow and path plans between the zones.

A management system for a plurality of working machines may include a networked server system, a project request source device, and at least a first working machine. The server controller may receive a project request from the project request source. The project request may include project information, including a site plan and a project activity. The server controller may then analyze the project request to identify the project information. A mission planning system of the networked server may generate a project layout for the project based on the project information and site plan. The mission planning system may also assign a first section from the project layout to the first working machine. The mission planning system may evaluate first machine information for the first working machine and determines a first set of field boundaries based on the first machine information and the first section assigned from the project layout. The mission planning system may then generate a first mission plan based on the first set of field boundaries and the project activity. This first mission plan may include machine instructions for the first working machine. The networked server may transmit the first mission plan to the first working machine over the communication network. In some embodiments, the mission planning system may also assign a second section of the project layout to a second working machine and develop a second mission plan for the second working machine. The second mission plan is based on a second set of field boundaries and the project activity.

In some embodiments, the networked server may receive a project modification request to change working machines. In response to the project modification request, the mission planning system may determine an uncompleted area of the project layout and an available section of the project layout by opening a portion of first section in the uncompleted area. The mission planning system may then reassign the available section of the project layout to a different working machine of the plurality of working machines. When the project modification request is to remove the first working machine from the project, determining the available section of the project layout may include cancelling the first working machine's assignment in the uncompleted area. When the project modification request is to add a new working machine to the project, determining the available section of the project layout may include opening the portion of the first section assigned to the first working machine.

Most of the equipment discussed above comprises hardware and associated software. For example, the typical working machine is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

The invention being thus described and further described in the claims, it will be obvious that the same may be varied in many ways. Such variations are not to be regarded as a departure from the spirit and scope of the invention, and all such modifications as would be obvious to one skilled in the art are intended to be included within the scope of the apparatus described.

1. A management system for a plurality of working machines, comprising:
a networked server system, comprising a server memory and a server controller operatively connected to, and configured to manage, the server memory;
a project request source device, comprising a user interface including a display and user input device, and a device control unit including a device processor and a device memory, wherein the device control unit is configured to manage the user interface, and wherein the project request source device is communicatively coupled via a communication network to the networked server system;
a first working machine, which is one of the plurality of working machines, comprising a first application gateway configured to communicate with the networked server system over the communication network, a first machine control unit comprising a first processor and a first memory, which stores first machine operating instructions, a first machine actuator system having a first machine control actuator, and a first automation sensor;
wherein the server controller receives a project request from the project request source device, and wherein the project request is for a project and includes project information, including a site plan and a project activity, and wherein the server controller analyzes the project request to identify the project information;
wherein a mission planning system of the networked server system generates a swath layout for the project based on the project information, wherein the mission planning system assigns a first section from the swath layout to the first working machine;
wherein the mission planning system evaluates first machine information for the first working machine and determines a first path plan based on the first machine information and the first section assigned from the swath layout;
wherein the mission planning system generates a first mission plan based on the first path plan and the project activity, and wherein the first mission plan includes machine instructions for the first working machine; and
wherein the networked server system transmits the first mission plan to the first working machine over the communication network.

2. The management system of claim 1, wherein the mission planning system assigns a second section of the swath layout to a second working machine, which is one of the plurality of working machines, and develops a second mission plan for the second working machine, wherein the second mission plan is based on a second path plan and the project activity.

3. The management system of claim 1, wherein the networked server system sends the swath layout to the project request source device, and the networked server system receives swath selection information from the project request source device.

4. The management system of claim 1, wherein the networked server system receives a project modification request to change working machines and, in response to the project modification request, the mission planning system determines an uncompleted area of the swath layout and reassigns an available section of the uncompleted area of the swath layout from an assigned working machine to a different working machine of the plurality of working machines.

5. The management system of claim 4, wherein the available section includes at least a portion of the first section and the assigned working machine is the first working machine, and the project modification request includes removing the first working machine from the project and opening the available section of the uncompleted area to the different working machine.

6. The management system of claim 4, wherein the different working machine is a new working machine and the project modification request includes adding the new working machine to the project.

7. The management system of claim 6, wherein, in response to the project modification request, the mission planning system determines the available section of the uncompleted area of the swath layout by opening swath sections that are assigned to the plurality of working machines.

8. The management system of claim 4, wherein the networked server system sends pause notifications to each active working machine of the plurality of working machines in the project when the project modification request is received.

9. The management system of claim 4, wherein the networked server system receives the project modification request from the project request source device.

10. The management system of claim 4, wherein the networked server system receives the project modification request from the first working machine.

11. The management system of claim 1, wherein the mission planning system assigns swath sections based on machine block assignments.

12. A management system for a plurality of working machines, comprising:
a networked server system, comprising a server memory and a server controller operatively connected to, and configured to manage the server memory;
a project request source device, comprising a user interface including a display and user input device, and a device control unit including a device processor and a device memory, wherein the device control unit is configured to manage the user interface, and wherein the project request source device is communicatively coupled via a communication network to the networked server system;
a first working machine, which is one of the plurality of working machines, comprising a first application gateway configured to communicate with the networked server system over the communication network, a first machine control unit comprising a first processor and a first memory, which stores first machine operating instructions, a first machine actuator system having a first machine control actuator, and a first automation sensor;
wherein the server controller receives a project request from the project request source device, and wherein the project request is for a project and includes project information, including a site plan and a project activity, and wherein the server controller analyzes the project request to identify the project information;
wherein a mission planning system of the networked server system generates a project layout for the project based on the project information, wherein the mission planning system assigns a first section from the project layout to the first working machine;
wherein the mission planning system evaluates first machine information for the first working machine and determines a first set of field boundaries based on the first machine information and the first section assigned from the project layout;
wherein the mission planning system generates a first mission plan based on the first set of field boundaries and the project activity, and wherein the first mission plan includes machine instructions for the first working machine; and
wherein the networked server system transmits the first mission plan to the first working machine over the communication network.

13. The management system of claim 12, wherein the mission planning system assigns a second section of the project layout to a second working machine, which is one of the plurality of working machines, and develops a second mission plan for the second working machine, wherein the second mission plan is based on a second set of field boundaries and the project activity.

14. The management system of claim 12, wherein the networked server system receives a project modification request to change working machines and, in response to the project modification request, the mission planning system determines an uncompleted area of the project layout and reassigns an available section of the uncompleted area of the project layout from an assigned working machine to a different working machine of the plurality of working machines.

15. The management system of claim 14, wherein the available section includes at least a portion of the first section and the assigned working machine is the first working machine, and the project modification request includes removing the first working machine from the project and opening the available section of the uncompleted area to the different working machine.

16. The management system of claim 14, wherein the different working machine is a new working machine and the project modification request includes adding the new working machine to the project.

17. The management system of claim 14, wherein the networked server system sends pause notifications to each active working machine of the plurality of working machines in the project when the project modification request is received.

18. The management system of claim 14, wherein the networked server system receives the project modification request from the project request source.

19. The management system for a plurality of working machines of claim 14, wherein the networked server system receives the project modification request from the first working machine.
